(19) United States
(12) Patent Application Publication
(10) Pub. No.: US 2026/0067185 A1
(43) Pub. Date: Mar. 5, 2026

(54) INTEGRATION AND DISPLAY OF NETWORK DATA FLOW EXTERNAL TO A SERVICE MESH

(71) Applicant: RED HAT, INC., Raleigh, NC (US)

(72) Inventors: John Mazzitelli, Trenton, NJ (US); Jay Shaughnessy, Trenton, NJ (US)

(21) Appl. No.: 18/817,866

(22) Filed: Aug. 28, 2024

(51) Int. Cl. H04L 43/045; H04L 43/062

(52) U.S. Cl. CPC H04L 43/045; H04L 43/062

(57) ABSTRACT

Network traffic external to a service mesh can be analyzed and displayed. For example, a system can receive first telemetry data associated with a service mesh and can receive second telemetry data associated with an external virtual application network. The system may then determine at least one connection point between the service mesh and the external virtual application network based on a comparison of the first telemetry data and the second telemetry data. The connection point can include a flow of network traffic between the service mesh and the external virtual application network. Additionally, the system can generate a graphical user interface, which can include a first section associated with the service mesh, a second section associated with the external virtual application network, and a visual indicator of the connection point between service mesh and external virtual application network.

### TECHNICAL FIELD

The present disclosure relates generally to service meshes. More specifically, but not by way of limitation, this disclosure relates to integrating and displaying network traffic that is external to a service mesh with network traffic internal to the service mesh.

### BACKGROUND

A service mesh is an infrastructural layer that manages service-to-service communication in a distributed computing environment, such as a cloud computing environment or computer cluster. The service mesh can be a separate infrastructure layer on top of a container orchestration platform, such as Kubernetes. The service mesh can include a data plane and a control plane. The data plane can forward traffic through the service mesh using proxies (e.g., sidecars). The control plane can handle the configuration, administrative, security and monitoring related functions of the service mesh. To that end, the control plane can interface with the data plane to define how the data plane functions, for example to coordinate the data flow among the proxies in the data plane. One popular type of service mesh is the Istio™ service mesh, which uses proxies called “Envoy™ sidecars” to facilitate communication among services.

### BRIEF DESCRIPTION OF THE DRAWINGS

FIG. 1 is a block diagram of an example of a distributed computing environment for integrating and displaying network traffic that is external to a service mesh with network traffic internal to the service mesh according to some aspects of the present disclosure.

FIG. 2 is a block diagram of an example of a computing device for integrating and displaying network traffic that is external to a service mesh with network traffic internal to the service mesh according to some aspects of the present disclosure.

FIG. 3 is a flow chart of an example of a process for integrating and displaying network traffic that is external to a service mesh with network traffic internal to the service mesh according to some aspects of the present disclosure.

FIG. 4 is a block diagram of a graphical user interface for displaying network traffic that is external to a service mesh with network traffic internal to the service mesh according to some aspects of the present disclosure.

### DETAILED DESCRIPTION

A service mesh may coordinate service-to-service communication for services in a distributed computing environment. That is, a service mesh can coordinate the flow of network traffic between the services in the distributed computing environment. At least some of the services in a service mesh can also communicate with applications and services that are external to the service mesh (e.g., databases running in virtual machines outside of the service mesh). The applications and services that are external to the service mesh may send and receive network traffic over external virtual application networks (VANs). There can be service mesh tools (e.g., Kiali) that can obtain and graph telemetry data (i.e., data describing network traffic) for the service mesh. However, such service mesh tools cannot ingest (e.g., obtain, understand, or a combination thereof) telemetry data associated with the external VANs. For example, the telemetry data associated with the external VANs can be stored in a separate database from the telemetry data associated with the service mesh and can have a different schema than the telemetry data associated with the service mesh. Consequently, the service mesh tools cannot obtain information about network traffic external to the service mesh, including information about network traffic flowing between the services in the service mesh and the external applications and services.

Due to the current systems'(i.e., the service mesh tools') inability to ingest telemetry data associated with external VANs, the current systems cannot provide information related to the flow of data between the service mesh and the VAN. This can cause various problems for the service mesh and related network traffic. For example, the inability to monitor and identify where network traffic leaving the service mesh is going or where network traffic entering the service mesh is coming from can render the service mesh vulnerable to security breaches (e.g., unauthorized access to data leaving the service mesh). It can further be difficult to diagnose causes of network congestion or performance degradation associated with the service mesh without an understanding of the flow of data between services internal to the service mesh and application or services external to the service mesh.

Some aspects of the present disclosure may overcome one or more of the abovementioned problems by a service mesh integration system that can integrate and display network traffic that is external to a service mesh with network traffic internal to the service mesh. To do so, the service mesh integration system may receive first telemetry data associated with the service mesh and second telemetry data associated with an external VAN. The service mesh integration system may then analyze the first and second telemetry data to determine connection points between the service mesh and the external VAN. The connection points can include a component (e.g., a service, a service node, a cluster, or the like) of the service mesh that transmitted network traffic (e.g., request, data, etc.) that exited the service mesh and a component (e.g., an application node, cluster, or the like) of the external VAN which received the network traffic. Conversely, in some examples, the connection points can include a component (e.g., a service, a service node, a cluster, or the like) of the service mesh which received network traffic that entered the service mesh and a component (e.g., an application node, cluster, or the like) of the external VAN which transmitted the network traffic.

The service mesh integration system may then generate a graphical user interface with a visual indicator of the connection points or may otherwise generate an output indicative of the connection points. In this way, the service mesh integration system can provide information indicative of where network traffic (e.g., data) entered or exited the service mesh, where the network traffic was received or transmitted from, or a combination thereof. This can facilitate improved detection of security breaches with respect to the service mesh by, for example, enabling detection unauthorized data transfers to or from the service mesh. Additionally, by providing the locations to which network traffic from the service mesh is going or from which the network traffic is being received, causes of network congestion or other types of performance degradation at the service mesh can be more easily identified and resolved.

In one particular example, a service mesh integration system can receive first telemetry data associated with an Istio service mesh (i.e., data describing the flow of network traffic in the Istio service mesh). In particular, the service mesh integration system may retrieve the first telemetry data from a first Prometheus database. To obtain the first telemetry data, the service mesh integration system may perform a series of database queries with respect to the first Prometheus database, may perform a series of Kubernetes API calls, or the like. The service mesh integration system may use a first set of appenders, which may be written as Go functions, to perform the database queries, the API calls, or the combination thereof. From the database queries, the service mesh integration system can obtain data identifying service nodes (e.g., logical units that represent services, workloads, applications, or the like) of the service mesh and identifying how data flows between the service nodes of the service mesh. From the Kubernetes API calls, the service mesh can obtain additional data related to the services. For example, the service mesh can be running within a Kubernetes cluster and the appenders can make the API calls to the cluster to obtain information about the services (e.g., service names, namespaces, labels, selectors, etc. of the services) in the cluster. The API calls can further be made to obtain information that relates the services to particular workloads or pods of the cluster, which can provide insight into data flow between the services.

The service mesh integration system can further receive second telemetry data associated with a VAN (i.e., data describing the flow of network traffic in the VAN). The VAN can be a network paradigm that facilitates secure and efficient communication across clusters (e.g., Kubernetes clusters). The VAN can enhance the service mesh by facilitating communication between services of the service mesh and applications, services, or the like of one or more clusters external to the service mesh. The service mesh integration system may retrieve the second telemetry data from a second Prometheus database. To obtain the second telemetry data, the service mesh integration system may perform a series of database queries with respect to the second Prometheus database using additional appenders. The data related to the VAN and stored in the second Prometheus database can have a different schema than the data related to the service mesh and stored in the first Prometheus database. Therefore, the additional appenders can be Go functions and can be adapted to the schema of the data in the second Prometheus database. From the database queries, the service mesh integration system can obtain data identifying application nodes (e.g., logical units that represent clusters, workloads, applications, or the like) of the VAN and identifying how data flows between the application nodes of the VAN.

Once the service mesh integration system has obtained the first and second telemetry data, the service mesh integration system can compare the first telemetry data to the second telemetry data to determine at least one connection point between the service mesh and the VAN. For example, the schema of the second telemetry data can be known to the service mesh integration system such that the system can examine the second telemetry data and identify IP addresses related to each of the application nodes. A schema of the first telemetry data can also be known to the service mesh integration system such that the service mesh integration system can examine the first telemetry data to determine source IP addresses and destination IP addresses for data that exited the service mesh. A source IP address can be an IP address associated with the service that transmitted the data and the destination IP address can indicate where the data is being transmitted. In comparing the first telemetry data to the second telemetry data, the service mesh integration system can match one or more of the destination IP addresses to one or more of the IP addresses of application nodes. The service mesh integration system can therefore identify the service nodes from which the data was transmitted (e.g., based on the source IP addresses) and the application nodes at which the data was received (e.g., based on matching the destination IP addresses with the IP addresses of the application nodes). Consequently, the service mesh integration system can identify at least one connection point between the service mesh and the VAN, which can include, for example, a service node that transmitted the data and an application node which received the data.

Additionally, the service mesh integration system can generate a graphical user interface (GUI) based on the first telemetry data, the second telemetry data, and the identified connection points between the VAN and the service mesh. For example, based on information regarding the flow of network traffic between services in the service mesh (i.e., the first telemetry data), the service mesh integration system can output a first visual representation of the service mesh in a first section of the GUI. Similarly, based on information regarding the flow of network traffic between applications and clusters in the VAN (i.e., the second telemetry data), the service mesh integration system can output a second visual representation of the VAN in a second section of the GUI. The service mesh integration system can further output a visual indicator of the connection point between service mesh and external virtual application network. For example, a connection point (e.g., a flow of data from the service mesh to the VAN) can be represented by a line between the service node of the service mesh and the application node of the VAN.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

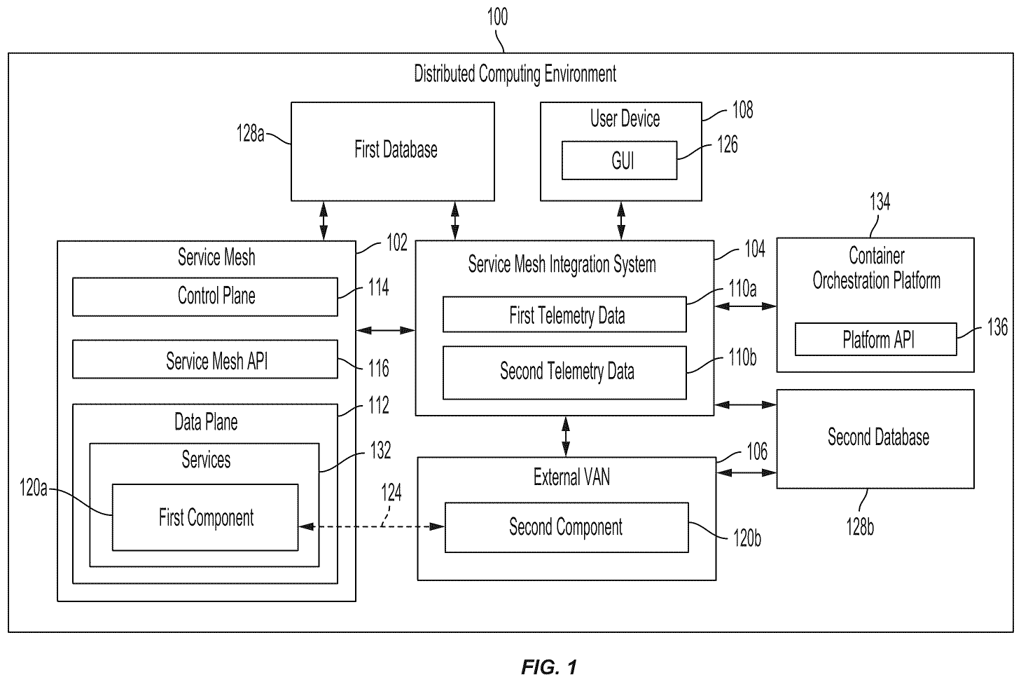

FIG. 1 is a block diagram of an example of a distributed computing environment 100 for integrating and displaying network traffic that is external to a service mesh 102 with network traffic internal to the service mesh 102 according to some aspects of the present disclosure. The distributed computing environment 100 may include multiple services 132 that communicate with one another via endpoints in the service mesh 102. Instances of the services 132 may run in containers coordinated by a container orchestration platform 134. The containers may be deployed in pods by the container orchestration platform 134. In some examples, the service mesh 102 may be the Istio™ service mesh and may employ Envoy™ sidecar proxies as the endpoints. Alternatively, the distributed computing environment 100 may include other types of service meshes (e.g., Linux Foundation Linkerd™, Hashicorp Consul®, etc.), proxies (e.g., NGINX®, HAProxy®, etc.), and container orchestration platforms (e.g., Docker Swarm®, Aprache Mesos®, etc.).

The container orchestration platform 134 may include a platform application-programming interface (API) 136 usable to configure settings for the container orchestration platform 134. The platform API 136 may be a built-in part of the container orchestration platform 134, for example that is shipped with the container orchestration platform 134. The settings 138 can include configurable settings for hardware components (e.g., storage devices, memory devices, and processors) and software components (e.g., containers, software applications, etc.) of the distributed computing environment 100. The settings can additionally include data related to the execution of the services 132 within the distributed computing environment 100, such as workload data, instance data, and container data. A service mesh integration system 104 may access the settings from the platform API 136, for example by transmitting a request for the settings 138 to the platform API 136.

The service mesh 102 can include a data plane 112 and a control plane 114. The data plane 112 can include the endpoints for the services 132. For example, each service may be associated with a corresponding endpoint for handling communication for that service. The control plane 114 can configure and coordinate the endpoints in the data plane 112 to enable communications between services. For example, the control plane 114 may convert high-level routing rules that control traffic behavior into specific configurations for endpoints associated with containers or pods and propagate the rules to the endpoints at runtime. In some examples, the control plane 114 can serve as a layer of abstraction that insulates the service mesh 102 from the underlying configuration and details of the container orchestration platform 134 on which the service mesh 102 may be running.

The service mesh 102 can also include a service mesh API 116. The service mesh API 116 can include settings for the control plane 114. The settings can include configuration settings, administrative settings, security settings, and monitoring settings. Examples of the configuration settings may include network settings applicable to the data plane 112 to control traffic flow through the data plane 112. The settings may also include other information relating to operation of the data plane 112, such as workloads, services, namespaces, configuration objects, and synchronization information associated with the data plane 112. The service mesh integration system 104 may access the settings by interacting with the service mesh API 116, for example by transmitting a request to the service mesh API 116.

Additionally, there can be a service mesh tool associated with the service mesh 102. The service mesh tool can be configured to monitor the service mesh 102 and to obtain metrics associated with network traffic in the service mesh 102 from the service mesh API 116, the platform API 136, the sidecar proxies or other suitable endpoints, other components of the service mesh 102, or a combination thereof. Examples of service mesh tool can include Prometheus, Grafana, Jaegar, Zipkin, Kiali, etc. The metrics obtained by the service mesh tool can include request rates, response times, error rates, etc. for service-to-service communications throughout the service mesh 102. The service mesh tool may further store the metrics in a first database 128a associated with the service mesh 102 and accessible by the service mesh integration system 104.

Additionally, in the first database 128a, the metrics can be associated with labels, which can provide additional insight into the flow of data between the services 132. For example, the labels may include an indication (e.g., a name or identifier) of a workload, service, container, namespace, or cluster sending an instance of network traffic (e.g., one or more requests, data packets, or the like), an indication (e.g., a name or identifier) of a workload, service, container, namespace, or cluster receiving the instance of network traffic, a status of the network traffic (e.g., whether or not an error occurred during transmission), a protocol used to transmit the network traffic, etc. Therefore, the first database 128a can include metrics for various instances of network traffic in the service mesh 102 as well as labels indicative of the flow of network traffic with respect to the service mesh 102.

The service mesh integration system 104 can request first telemetry data 110a from the platform API, service mesh API, the service mesh tool, the first database 128, or a combination thereof. The first telemetry data 110a can describe the flow of network traffic in the service mesh 102. The network traffic in the service mesh 102 can include any communication or interaction between the services 132 in the service mesh 102. The first telemetry data 110a can describe which services are communicating or interacting and can characterize the communication or interaction. The communication or interaction can be characterized by the metrics (e.g., request count, request rate, request latency, response size, response time, error rate, etc.) obtained by the service mesh tool. The communication or interaction can further be characterized by the protocol (e.g., HTTP, FTP, TCP, etc.), encryption technique, or the like used for the network traffic. Accordingly, the first telemetry data 110a can include the metrics, labels, settings, other data related to the service mesh 102, or a combination thereof.

In some examples, some of the services 132 can communicate or interact with external (i.e., non-mesh) services or applications (e.g., databases running in virtual machines outside of the service mesh 102). Consequently, some of the network traffic associated with the service mesh 102 can exit the service mesh 102 to facilitate the communication or interactions with the non-mesh applications and services. These applications and services which are external to the service mesh 102 can send and receive network traffic over virtual application networks (VANS) that are external to the service mesh 102 (e.g., external VAN 106). A VAN can be a network paradigm that facilitates secure and efficient communication across clusters (e.g., Kubernetes clusters). The external VAN 106 can enhance the service mesh 102 by facilitating communication between the services 132 internal to the service mesh 102 and applications, services, or the like of one or more clusters external to the service mesh 102. Thus, in some examples, service mesh network traffic can enter the external VAN 106, VAN network traffic from the external VAN 106 can enter into the service mesh 102, or a combination thereof.

The container orchestration platform 134 may provide VAN tools (e.g., Skupper or Red Hat Service Interconnect) for creating, managing, and monitoring VANs. Such VAN tools can capture second telemetry data 110b describing network traffic in the external VAN 106. For example, a VAN tool may generate metrics based on network traffic in the external VAN 106 and may store the metrics in the second database 128b. The metrics can provide insights into performance, reliability, and traffic pattens between clusters in the external VAN 106. Examples of the metrics can include a total number of bytes transmitted between two or more clusters, a total number of data packets being transmitted between two or more clusters, a total number of bytes or data packets received at a cluster, a number of active connections between clusters, error rates or response times for request transmission between clusters, etc.

Additionally, in the second database 128b, the metrics can be associated with labels, which can provide additional insight into the flow of data between clusters. For example, the labels may include a name of a source cluster (e.g., a cluster from network traffic may be sent), a name of a destination cluster (e.g., a cluster to which the network traffic is being sent), a name of a service or namespace within the source cluster from which the network traffic (e.g., a request, data packet, or the like) originated, a name of a service or namespace within the destination cluster to which the network traffic was sent, a protocol (e.g., HTTP, TCP, etc.) used for the network traffic, etc. Thus, similar to the first database 128a, the second database 128b can include metrics for various instances of network traffic in the external VAN 106 as well as labels indicative of the flow of network traffic with respect to the external VAN 106.

The service mesh integration system 104 can request the second telemetry data 110b from the VAN tools, the second database 128b, the platform API 136, or a combination thereof. The second telemetry data 110b can describe the flow of network traffic in the external VAN 106. The network traffic of the external VAN 106 can be defined as any communication or interaction between the clusters, applications, services, or the like of the external VAN 106. The second telemetry data 110b can therefore describe which clusters (or which services or applications within the clusters) are communicating or interacting. The communication or interactions can further be characterized by the metrics (e.g., a number of bytes or data packets, error rates, response times, etc.) obtained by the VAN tool. The communication or interaction can further be characterized by the protocol (e.g., HTTP, FTP, TCP, etc.), encryption technique, or the like used for the network traffic of the external VAN 106. Accordingly, the second telemetry data 110b can include the metrics, labels, other data related to the external VAN 106, or a combination thereof.

Although the first telemetry data 110a and the second telemetry data 110b can include similar data (e.g., metrics and labels indicative of network traffic in the service mesh 102 and external VAN 106 respectively), in some examples, a schema of the first telemetry data 110a obtained from the first database 128a can be different from a schema of the second telemetry data 110b obtained from the second database 128b. Each of the schemas can be provided to the service mesh integration system 104 to enable the service mesh integration system 104 to ingest and compare both telemetry data sets 110a-b. Additionally or alternatively, the service mesh integration system 104 can transform the first telemetry data 110a, the second telemetry data 110b, or a combination thereof to facilitate ingestion and comparison. For example, the first telemetry data 110a can be transformed into a format (e.g., schema) that is more similar to the schema of the second telemetry data 110b or vice versa.

The service mesh integration system 104 can further compare the first and second telemetry data 110a-b to determine connection points between the service mesh 102 and the external VAN 106. In doing so, the service mesh integration system 104 can facilitate an improved understanding of behavior of the services 132, which, in turn, can enable improved troubleshooting, debugging, performance analysis, etc. of the services 132.

In some examples, the first telemetry data 110a may include first indications (e.g., labels) of a destination cluster, a destination namespace, a destination service, a destination IP address, or a combination thereof for network traffic transmitted by a particular service in the service mesh 102. That is, the first telemetry data 110a can include one or more labels indicative of a particular cluster, namespace, service, IP address, or a combination thereof to which network traffic from the particular service is being sent. The second telemetry data 110b can similarly include second indications of one or more clusters, namespaces, services, or IP addresses in the external VAN 106. For example, the labels in the second telemetry data 110b can be indicative of (e.g., have names or identifiers for) the clusters, namespaces, services, IP addresses, or a combination thereof within the external VAN 106.

In some examples, to determine a connection point 124 between the service mesh 102 and the external VAN 106, service mesh integration system 104 can determine a first component 120a (e.g., the particular service) of the service mesh 102 that is transmitting requests, data, or otherwise communicating with the external VAN 106. The service mesh integration system 104 may determine that the particular service is communicating with the external VAN 106 (i.e., transmitting network traffic that exited the service mesh 102) based on the destination cluster, the destination namespace, the destination service, the destination IP address, or the combination thereof for network traffic from the particular service as included in the first telemetry data 110a. That is, the service mesh integration system 104 may detect, using the first telemetry data 110a, that the destination cluster, the destination namespace, the destination service, and/or the destination IP address is not within the service mesh 102.

Additionally, to determine the connection point 124 between the service mesh 102 and the external VAN 106, the service mesh integration system 104 can determine a second component 120b (e.g., a cluster, container, namespace, service, or application) of the external VAN 106 that received the request, data, or is otherwise communicating with the particular service. The service mesh integration system 104 may determine the second component 120b based on the destination cluster, the destination namespace, the destination service, and/or the destination IP address for network traffic from the particular service matching a name of a cluster, namespace, service, and/or IP address of the external VAN 106. That is, the service mesh integration system 104 may detect, based on labels in the second telemetry data 110b, that the destination cluster, the destination namespace, the destination service, and/or the destination IP address matches a cluster, namespace, service, and/or IP address in the external VAN 106. In other words, the service mesh integration system 104 may determine the connection point 124 by detecting a match between the first indications from the first telemetry data 110a and the second indications from the second telemetry data 110b.

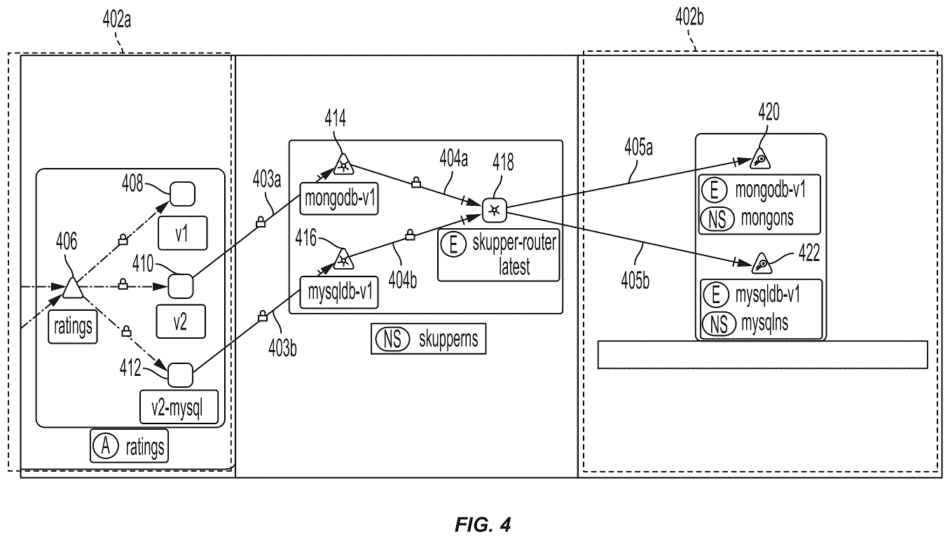

The service mesh integration system 104 can further generate a graphical user interface (GUI) 126, which can include a first visual representation of the service mesh 102, a second visual representation of the external VAN 106, and one or more visual indicators of one or more connection points (e.g., connection point 124) between the service mesh 102 and external VAN 106. To generate the first visual representation, the service mesh integration system 104 may graph the first telemetry data 110a (i.e., the data describing network traffic in the service mesh 102) in a first section of the GUI 126. For the second visual representation, the service mesh integration system 104 may graph the second telemetry data (i.e., the data describing network traffic in the external VAN 106) in a second section of the GUI 126. The first section of the GUI 126 may include a graphical element (graphical element 412 of FIG. 4) representative of the first component 120a and the second section of the GUI 126 may include a second graphical element (e.g., graphical element 420 of FIG. 4) representative of the second component 120b. The visual indicator of the connection point 124 between service mesh 102 and external VAN 106 may then be one or more lines or other connecting elements (e.g., lines 403a, 404a, and 405a of FIG. 4) extending between the graphical elements. The GUI 126 can be displayed at a user device 108 of the distributed computing environment 100. Examples of the user device can include a laptop, tablet, personal computer, or the like. An example of the GUI 126 is shown and described below with respect to FIG. 4.

While FIG. 1 depicts a specific arrangement of components, other examples can include more components, fewer components, different components, or a different arrangement of the components shown in FIG. 1. Additionally, any component or combination of components depicted in FIG. 1 can be used to implement the process(es) described herein.

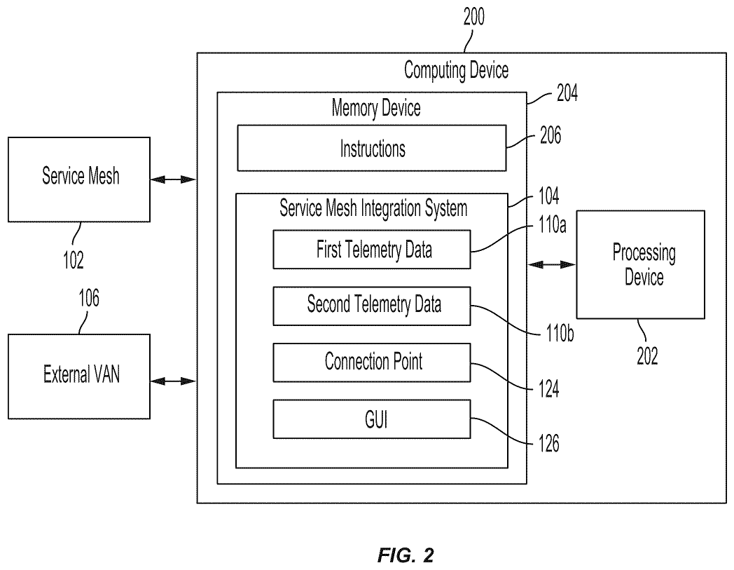

FIG. 2 is a block diagram of an example of a computing device 200 for integrating and displaying network traffic that is external to a service mesh with network traffic internal to the service mesh according to some aspects of the present disclosure. The computing device 200 includes a processing device 202 communicatively coupled to a memory device 204. In some examples, the processing device 202 and the memory device 204 can be part of a distributed computing environment, such as the distributed computing environment 100 of FIG. 1.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C #, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code executable to perform operations. Non-limiting examples of a computer-readable medium include magnetic disk(s), memory chip(s), ROM, random-access memory (RAM), an ASIC, a configured processor, and optical storage.

In some examples, the processing device 202 can execute the instructions 206 to perform operations. Additionally or alternatively, in some examples, the memory device 204 includes a service mesh integration system 104 that can be executed by the processing device 202 to perform the operations. In either case, the processing device 202 can receive first telemetry data 110a associated with the service mesh 102. Additionally, the processing device 202 can receive second telemetry data 110b associated with an external virtual application network (VAN) 106. The processing device 202 can further determine at least one connection point 124 between the service mesh 102 and the external VAN 106 based on a comparison of the first telemetry data 110a and the second telemetry data 110b. The connection point 124 can include a flow of network traffic between the service mesh 102 and the external VAN 106. Moreover, based on the comparison, the processing device 202 can generate a graphical user interface (GUI) 126. The GUI 126 can include a first section associated with the service mesh 102, a second section associated with the external VAN 106, and a visual indicator of the connection point 124 between service mesh 102 and external VAN 106.

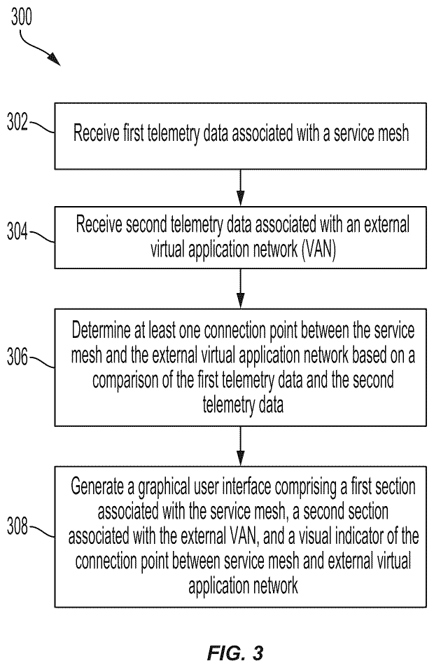

FIG. 3 is a flow chart of an example of a process 300 for displaying network traffic that is external to a service mesh according to some aspects of the present disclosure. For example, the processing device 202 can execute the service mesh integration system 104 of FIG. 1 to perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

At block 302, the processing device 202 can receive first telemetry data 110a associated with a service mesh 102. The processing device 202 may request (e.g., by executing database queries) the first telemetry data 110a from a first database 128a. The first database 128a can be associated with a monitoring system such as Prometheus. Various metrics obtained by the monitoring system and associated with the service mesh 102 can therefore be stored in the first database 128a as, for example, time series data. Examples of such metrics can include request rates, response times, error rates, etc. for service-to-service communications throughout the service mesh 102. Additionally, the time series data in the first database 128a can be associated with labels, which can provide additional insight into the flow of data between services. For example, the labels may include a name of a workload sending a network traffic (e.g., a request, data packet, or the like), a name of a workload receiving the network traffic, a status of the network traffic (e.g., whether or not an error occurred during transmission), a name of the service, namespace, or cluster to which the network traffic is being sent, the protocol used for the request, etc. Therefore, the first telemetry data 110a (i.e., the data describing the flow of network traffic in the service mesh 102) can include the time series data and corresponding labels associated with the service mesh 102 from the first database 128a.

At block 304, the processing device 202 can receive second telemetry data 110b associated with an external virtual application network (VAN) 106. The processing device 202 may request (e.g., by executing database queries) the second telemetry data 110b from a second database 128b. The second database 128b can be associated with a monitoring system such as Prometheus. In some examples, the same monitoring system can generate and store data for the service mesh 102 and external VAN 106. In other examples, the monitoring system generating and storing the data for the service mesh 102 and can be different from the monitoring system associated with the external VAN 106. For example, there may be a service mesh tool for generating and storing the data for the service mesh 102 and a separate, VAN tool for generating and storing the data for the external VAN 106.

Various metrics obtained by the monitoring system and associated with the external VAN 106 can be stored in the second database 128b as, for example, time series data. The metrics can provide insights into performance, reliability, and traffic pattens between clusters in the external VAN. Examples of the metrics can include a total number of bytes transmitted between two or more clusters, a total number of data packets being transmitted between two or more clusters, a total number of bytes or data packets received at a cluster, a number of active connections between clusters, error rates or response times for request transmission between clusters, etc. Additionally, the time series data in the second database 128b can be associated with labels, which can provide additional insight into the flow of data between cluster. For example, the labels may include a name of a source cluster (e.g., a cluster from network traffic may be sent), a name of a destination cluster (e.g., a cluster to which the network traffic is being sent), a name of a source service or namespace within the source cluster from which the network traffic (e.g., a request, data packet, or the like) originated, a name of a destination service or namespace within the destination cluster to which the network traffic was sent, a protocol (e.g., HTTP, TCP, etc.) used for the network traffic, etc. Therefore, the second telemetry data 110b (i.e., the data describing the flow of network traffic in the external VAN 106) can include the time series data and corresponding labels associated with the external VAN 106 from the second database 128b.

At block 306, the processing device 202 can compare the first telemetry data 110a to the second telemetry data 110b to determine at least one connection point 124 between the service mesh 102 and the external VAN 106. The connection point 124 can be a point at which there is a flow of network traffic between the service mesh 102 and the external VAN 106. The processing device 202 can, in some examples, compare the first telemetry data 110a to the second telemetry data 110b based on the labels. For example, as described above, the labels in the first telemetry data 110a can include a name of the service, a name of a namespace, a name of a cluster or a combination thereof to which network traffic from a particular service of the service mesh 102 has been sent. The labels in the second telemetry data 110b can also include names of services, namespaces, and clusters of the external VAN 106. By comparing the first telemetry data 110a to the second telemetry data 110b, the name of the service, namespace, and/or cluster can to which the network traffic was sent can be matched with a service, namespace, or cluster of the external VAN 106 with the same or a similar name. Consequently, the processing device 202 can determine that there is a connection point between the particular service of the service mesh 102 from which the network traffic was sent and the service, namespace, or cluster.

At block 308, the processing device 202 can, generate a graphical user interface (GUI) 126. The GUI 126 can include a first section associated with the service mesh 102, a second section associated with the external VAN 106, and a visual indicator of the connection point 124 between the service mesh 102 and the external VAN 106. For example, based the first telemetry data 110a, the processing device 202 can generate and output a first visual representation of the service mesh 102 in a first section of the GUI. The first visual representation can include service nodes, services, and indications of the flow of network traffic within the service mesh 102. Similarly, based on the second telemetry data 110b, the processing device 202 can generate and output a second visual representation of the external VAN 106 in a second section of the GUI 126. The second visual representation can include application nodes and indications of the flow of network traffic within the service mesh 102. The processing device 202 can further output a visual indicator of the connection point 124 between service mesh and external virtual application network. For example, the connection point can be represented by a line between a service of the service mesh and an application node associated with the cluster of the external VAN 106.

FIG. 4 is a block diagram of a graphical user interface (GUI) 126 for displaying network traffic that is external to a service mesh 102 according to some aspects of the present disclosure. The GUI 126 can include a first section 402a associated with the service mesh 102 and a second section 402b associated with the external VAN 106. The first section 402a can provide a visual representation of at least a portion of the service mesh 102. For example, the first section 402a can include a first graphical element 406 representative of a service node, which can be processing and routing requests to pods. The pods can be represented by third, fourth and fifth graphical elements 408, 410, 412. Similarly, the second section 402b can provide a visual representation of at least a portion of the external VAN 106. For example, there can be two more graphical elements 420, 422 in the second section 402b, which can represent application nodes, clusters, or other suitable components of the external VAN 106.

Between the first and second sections 402a-b there can be one or more connection points shown by one or more visual indicators. For example, the connection points can be represented by one or more lines between a component of the service mesh 402 and a component of the external VAN 106. In the example shown, a first pod can be transmitting network traffic to a first service API and a second pod can be transmitting network traffic to a second service API. The first and second service APIs can be associated with the service mesh 102 and configured to transmit data to the external VAN 106 via a VAN router (e.g., a skupper router). The first and second API services can be shown by graphical element 414 and graphical element 416 respectively, and the VAN router can be represented by graphical element 418.

The transmission of the network traffic (e.g., requests) to the API services from the pods can be shown by lines 403a-b, the forwarding of those requests to the VAN router can be shown by lines 404a-d, and the path of the request to the respective components (e.g., clusters) in the external VAN can be shown by lines 405a-b. Thus, visual indicators representative of the connection points (e.g., representative of the flow of network traffic) between the service mesh 102 and the external VAN can include the lines 403a-b, 404a-b, and 405a-b. In the example shown, the visual indicators representative of the connection points further includes the graphical elements 414, 416, 418, which represent the API services and VAN router which facilitate the flow of network between the service mesh 102 and the external VAN 106.

Additionally, as described above with respect to FIG. 1, the telemetry data 110a-b can include metrics (e.g., response rates, error rates, etc.) for the network traffic within and between the service mesh 102 and the external VAN 106. Thus, based on the metrics in the telemetry data 110a-b, the service mesh integration system 104 can determine performance metrics associated with the flow of network traffic within or between the service mesh 102 and the external VAN 106. The service mesh integration system 104 may then modify the GUI 126 based on the performance metrics. For example, the lines between graphical elements can be modified (e.g., can be different colors) based on error rates, protocols, response times, etc.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving first telemetry data associated with a service mesh;
receiving second telemetry data associated with an external virtual application network;
determining at least one connection point between the service mesh and the external virtual application network based on a comparison of the first telemetry data and the second telemetry data, the connection point comprising a flow of network traffic between the service mesh and the external virtual application network; and
generating a graphical user interface for display on a user device, the graphical user interface comprising a first section associated with the service mesh, a second section associated with the external virtual application network, and a visual indicator of the connection point between service mesh and external virtual application network.

2. The system of claim 1, wherein the operation of determining at least one connection point between the service mesh and the external virtual application network comprises:
determining, based on the first telemetry data, a first component of the service mesh that transmitted the network traffic; and
determining, based on the second telemetry data, a second component of the external virtual application network that received the network traffic,
wherein the connection point is between the first component and the second component.

3. The system of claim 2, wherein the first section of the graphical user interface comprises a first graphical element representative of the first component, wherein the second section of the graphical user interface comprises a second graphical element representative of the second component, and wherein the visual indicator of the connection point between service mesh and external virtual application network comprises a line connecting the first graphical element and the second graphical element.

4. The system of claim 1, wherein the operation of receiving the first telemetry data associated with the service mesh comprises querying a first database comprising time series data associated with the service mesh, and wherein the operation of receiving second telemetry data associated with the external virtual application network comprises querying a second database comprising time series data associated with the external virtual application network.

5. The system of claim 1, wherein the first telemetry data comprises a first indication of a destination cluster, a destination namespace, a destination service, or a destination IP address, and wherein the second telemetry data comprises a second indication of a cluster, a namespace, a service, or an IP address.

6. The system of claim 5, wherein the operation of determining at least one connection point between the service mesh and the external virtual application network comprises detecting a match between the first indication and the second indication.

7. The system of claim 1, wherein the operations further comprise:
determining at least one performance metric associated with the flow of network traffic between the service mesh and the external application based on the first telemetry data or the second telemetry data; and
modifying the visual indicator of the connection point based on the at least one performance metric.

8. A method comprising:
receiving first telemetry data associated with a service mesh;
receiving second telemetry data associated with an external virtual application network;
determining at least one connection point between the service mesh and the external virtual application network based on a comparison of the first telemetry data and the second telemetry data, the connection point comprising a flow of network traffic between the service mesh and the external virtual application network; and
generating a graphical user interface for display on a user device, the graphical user interface comprising a first section associated with the service mesh, a second section associated with the external virtual application network, and a visual indicator of the connection point between service mesh and external virtual application network.

9. The method of claim 8, wherein determining at least one connection point between the service mesh and the external virtual application network comprises:
determining, based on the first telemetry data, a first component of the service mesh that transmitted the network traffic; and
determining, based on the second telemetry data, a second component of the external virtual application network that received the network traffic,
wherein the network traffic comprises data that exited the service mesh and entered the external virtual application network, and wherein the connection point is between the first component and the second component.

10. The method of claim 9, wherein the first section of the graphical user interface comprises a first graphical element representative of the first component, wherein the second section of the graphical user interface comprises a second graphical element representative of the second component, and wherein the visual indicator of the connection point between service mesh and external virtual application network comprises a line connecting the first graphical element and the second graphical element.

11. The method of claim 8, wherein receiving the first telemetry data associated with the service mesh comprises querying a first database comprising time series data associated with the service mesh, and wherein receiving second telemetry data associated with the external virtual application network comprises querying a second database comprising time series data associated with the external virtual application network.

12. The method of claim 8, wherein the first telemetry data comprises a first indication of a destination cluster, a destination namespace, a destination service, or a destination IP address, and wherein the second telemetry data comprises a second indication of a cluster, a namespace, a service, or an IP address.

13. The method of claim 12, wherein determining at least one connection point between the service mesh and the external virtual application network comprises detecting a match between the first indication and the second indication.

14. The method of claim 8, further comprising:
determining at least one performance metric associated with the flow of network traffic between the service mesh and the external application based on the first telemetry data or the second telemetry data; and
modifying the visual indicator of the connection point based on the at least one performance metric.

15. A non-transitory computer-readable medium comprising program code executable by a processing device for causing the processing device to perform operations comprising:
receiving first telemetry data associated with a service mesh;
receiving second telemetry data associated with an external virtual application network;
determining at least one connection point between the service mesh and the external virtual application network based on a comparison of the first telemetry data and the second telemetry data, the connection point comprising a flow of network traffic between the service mesh and the external virtual application network; and
generating a graphical user interface for display on a user device, the graphical user interface comprising a first section associated with the service mesh, a second section associated with the external virtual application network, and a visual indicator of the connection point between service mesh and external virtual application network.

16. The non-transitory computer-readable medium of claim 15, wherein the operation of determining at least one connection point between the service mesh and the external virtual application network comprises:
determining, based on the first telemetry data, a first component of the service mesh that transmitted the network traffic; and
determining, based on the second telemetry data, a second component of the external virtual application network that received the network traffic,
wherein the network traffic comprises data that exited the service mesh and entered the external virtual application network, and wherein the connection point is between the first component and the second component.

17. The non-transitory computer-readable medium of claim 16, wherein the first section of the graphical user interface comprises a first graphical element representative of the first component, wherein the second section of the graphical user interface comprises a second graphical element representative of the second component, and wherein the visual indicator of the connection point between service mesh and external virtual application network comprises a line connecting the first graphical element and the second graphical element.

18. The non-transitory computer-readable medium of claim 15, wherein the operation of receiving the first telemetry data associated with the service mesh comprises querying a first database comprising time series data associated with the service mesh, and wherein the operation of receiving second telemetry data associated with the external virtual application network comprises querying a second database comprising time series data associated with the external virtual application network.

19. The non-transitory computer-readable medium of claim 15, wherein the first telemetry data comprises a first indication of a destination cluster, a destination namespace, a destination service, or a destination IP address, and wherein the second telemetry data comprises a second indication of a cluster, a namespace, a service, or an IP address.

20. The non-transitory computer-readable medium of claim 19, wherein the operation of determining at least one connection point between the service mesh and the external virtual application network comprises detecting a match between the first indication and the second indication.
